(19) United States
(12) Patent Application Publication
(10) Pub. No.: US 2016/0026764 A1
(43) Pub. Date: Jan. 28, 2016

(54) VIRTUAL DIAGNOSTIC TEST PANEL DEVICE, SYSTEM, METHOD AND COMPUTER READABLE MEDIUM

(71) Applicant: FIO Corporation, Toronto, (CA)

(72) Inventor: Francois DUPOTEAU, Toronto (CA)

(21) Appl. No.: 14/436,779

(22) PCT Filed: Oct. 18, 2013
(86) PCT No.: PCT/CA2013/000898

§ 371 Date: Apr. 17, 2015

Related U.S. Application Data
(60) Provisional application No. 61/715,587, filed on Oct. 18, 2012.

(51) Int. Cl. G06F 19/00

(52) U.S. Cl. CPC G06F 19/345

(57) ABSTRACT

A system virtually tests for diagnostic results in a subject, and includes databases and processors. The databases include test results, QC data, and diagnostic matrices. Each diagnostic matrix indicates one of the diagnostic results. The processors automatically apply: interpretation algorithms to generate result coordinates; and QC protocols to generate QC coordinates. The processors automatically: combine result coordinates with corresponding QC coordinates to generate a virtual test panel matrix; and when the virtual test panel matrix matches one or more of the diagnostic matrices, determine each aforesaid corresponding one of the diagnostic results which matches the virtual test panel matrix. Also disclosed are a device, method and computer readable medium.

### FIELD OF THE INVENTION

The present invention relates generally to a diagnostic device, system and method, and more particularly to a virtual diagnostic test panel device, system, method and computer readable medium to virtually test for one or more diagnostic results in a biological or environmental subject.

### BACKGROUND OF THE INVENTION

In the diagnostic industry, numerous and varied diagnostic devices, systems and/or methods may have been adapted to test for a particular biological and/or environmental condition associated with a subject. Some prior art diagnostic devices, systems and/or methods may have been adapted to test for a particular characteristic and/or for the presence of one or more specific chemicals, biomarkers, environmental agents, pathogens and/or disease states in a test sample. Some such devices, systems and/or methods may have included, for example, visual assessments by healthcare professionals, manually measured body temperatures, stethoscopes, and rapid diagnostic tests, panels and other diagnostic and/or medical equipment.

In the prior art, there may also have been computer-assisted diagnostic systems and methods, such as those which are the subject of U.S. Patent Application Publication No. 2010/0257027 for “A Method And System For Collating, Storing, Analyzing And Enabling Access To Collected And Analyzed Data Associated With Biological And Environmental Test Subjects”, and U.S. Patent Application Publication No. 2012/0154139 for “A Bio-Threat Alert Infrastructure System And Method, A Bio-Threat Alert Device, And A Method Of Alerting A User Thereof”, both assigned to Fio Corporation of Toronto, Canada. What may be needed is a virtual diagnostic test panel computer readable medium with stored executable instructions to enable a computer to virtual test for one or more diagnostic results in a biological or environmental subject.

Among those administering diagnostic tests, it may be known to use diagnostic results from two or more diagnostic devices, systems and/or methods to test for a given biological and/or environment condition associated with a subject. However, as may be appreciated by persons having ordinary skill in the art, the ability to combine results from different diagnostic devices, systems and/or methods may be limited by diagnostic results which (in the form provided) may be difficult, or even impossible, to combine or which may be associated with differing quality control standards and/or protocols. For example, it may be difficult, or even impossible, to combine a given qualitative test result with a given quantitative test result to obtain a meaningful diagnostic result. Further, it may be difficult, or impossible, to obtain a meaningful diagnostic result by combining two quantitative test results that are on different scales.

In the prior art, one problem associated with previous diagnostic devices, systems and/or methods may have been that they are only able to test for the particular conditions, characteristics, chemicals, markers, agents, pathogens and/or states for which they were originally designed and/or adapted. It may not have been possible to use the results of such prior art devices, systems and/or methods with one another, and/or to test for conditions, characteristics, chemicals, markers, agents, pathogens and/or states other than those for which they were originally designed and/or adapted.

One problem associated with using the test results of prior art devices, systems, and/or methods with one another may have been that each was subject to differing quality control standards and/or protocols, and/or that there was no way to readily account for these differences on combining the results.

Before now, the prior art may have failed to provide a virtual diagnostic test panel device, system and/or method which was specifically adapted to automatically combine the test results of various other diagnostic devices, systems and/or methods to test for biological conditions and/or characteristics, and/or for the presence of chemicals, biomarkers, environmental agents, pathogens and/or disease states other than those for which such diagnostic devices, systems and/or methods were originally designed and adapted.

Perhaps notably, the devices, systems and/or methods of the prior art may not have been adapted to solve one or more of the above-identified problems which may have negatively affected diagnostic devices, systems and/or methods. Devices, systems and/or methods of the prior art may not have been adapted to readily generate quantitative, semi-quantitative and/or qualitative test results in such a way as to facilitate combination with one another. Some prior art diagnostic test devices, systems and/or methods may not have been adapted to provide test results for use with diagnostic tests and/or to generate diagnostic results other than those which they were originally and/or specifically designed. Also, some prior art devices, systems and/or methods may not have been adapted to readily combine test results associated with differing quality control standards and/or protocols.

What may be needed is a device, system, method and/or computer readable medium which overcomes, traverses, obviates and/or mitigates one or more of the limitations associated with the prior art, and/or helps to do so. It may be advantageous to provide a device, system, method and/or computer readable medium which combines given test results that previously may have been difficult, or even impossible, to combine (e.g., qualitative, semi-quantitative and quantitative test results, on the same or different scales). It also may be advantageous to provide a device, system, method and/or computer readable medium which enables and/or facilitates the combination test results from different diagnostic tests to enable and/or facilitate the provision of diagnostic results other than those that each of the diagnostic tests was originally intended to provide. It may be advantageous to provide a device, system, method and/or computer readable medium adapted to combine test results which may be associated with differing quality control standards and/or protocols.

It may be an object of one aspect of the present invention to provide a diagnostic device, system, method and/or computer readable medium.

It may be an object of one aspect of the present invention to provide a device, system, method and/or computer readable medium to virtually test for one or more diagnostic results in a biological or environmental subject.

It may be an object of one aspect of the present invention to provide a device, system, method and/or computer readable medium which is adapted to associate test results collected from diagnostic tests with quality control (QC) data.

It may be an object of one aspect of the present invention to provide a device, system, method and/or computer readable medium which is adapted to apply interpretation algorithms to generate result coordinates based on the test results, and adapted to apply QC protocols to generate QC coordinates based on the QC data.

It may be an object of one aspect of the present invention to provide a device, system, method and/or computer readable medium which is adapted to generate result coordinates which are on the same scale as one another, and adapted to generate QC coordinates which are on the same scale as one another.

It may be an object of one aspect of the present invention to provide a device, system, method and/or computer readable medium which is adapted to generate a virtual test panel matrix by combining the result coordinates with their corresponding QC coordinates.

It may be an object of one aspect of the present invention to provide a device, system, method and/or computer readable medium which is adapted to determine any diagnostic matrices matching the virtual test panel matrix, and/or any diagnostic results which correspond to the diagnostic matrices that match the virtual test panel matrix.

It may be an object of one aspect of the present invention to provide a device, system, method and/or computer readable medium which is adapted to store algorithms for interpreting test results and/or protocols for assessing QC data in one or more databases.

It may be an object of one aspect of the present invention to provide a device, system, method and/or computer readable medium which is adapted to automatically retrieve algorithms from databases before using them to interpret test results, and/or adapted to automatically retrieve protocols from databases after QC data is associated with the test results.

It may be an object of one aspect of the present invention to provide a device, system, method and/or computer readable medium which is adapted to deliver interpretation algorithms and/or QC protocols for storage in one or more databases.

It may be an object of one aspect of the present invention to provide a device, system, method and/or computer readable medium which is adapted to generate result coordinates and/or QC coordinates as quantitative and/or semi-quantitative values.

It may be an object of one aspect of the present invention to provide a device, system, method and/or computer readable medium which is adapted to match points, defined by coordinates in a virtual test panel matrix, against ranges of accuracy for each diagnostic test in one or more diagnostic matrices.

It may be an object of one aspect of the present invention to provide a device, system, method and/or computer readable medium with ranges of accuracy in one or more diagnostic matrices which depend on aggregated clinical data.

It may be an object of one aspect of the present invention to provide a device, system, method and/or computer readable medium with ranges of accuracy in one or more diagnostic matrices which are defined by minimum and/or maximum result and/or QC values.

It may be an object of one aspect of the present invention to provide a device, system, method and/or computer readable medium which is adapted for use with clinical data observed from clinical examinations in combination with other test results from other diagnostic tests.

It may be an object of one aspect of the present invention to provide a device, system, method and/or computer readable medium which is adapted for use with test results and QC data that are collected using one or more diagnostic devices.

It may be an object of one aspect of the present invention to provide a device, system, method and/or computer readable medium which is adapted to automatically capture test results and QC data using one or more auto-capture devices which may or may not perform the diagnostic tests.

It may be an object of one aspect of the present invention to provide a device, system, method and/or computer readable medium which is adapted for use with one or more databases and/or processors that are each remote from and/or local to one or more diagnostic devices.

It may be an object of one aspect of the present invention to provide a device, system, method and/or computer readable medium which is adapted for use with test assay QC results, device calibration results, device functional check results, and/or test user QC results.

It may be an object of one aspect of the present invention to provide a device, system, method and/or computer readable medium which provides one or more protocols to assess QC data that depend on associated test assays, test devices, and/or test users.

It may be an object of one aspect of the present invention to provide a device, system, method and/or computer readable medium which provides for one or more databases distributed over a network.

It may be an object of one aspect of the present invention to provide a device, system, method and/or computer readable medium which provides for at least two congruent databases.

It may be an object of one aspect of the present invention to provide a device, system, method and/or computer readable medium which provides for one or more algorithms to interpret test results that depends on one or more ages, genders, locations and/or temperatures associated with the biological or environmental subject.

It may be an object of one aspect of the present invention to provide a virtual diagnostic test panel device, system, method and/or computer readable medium which is adapted to combine the test results from various diagnostic devices, systems and/or methods.

It may be an object of one aspect of the present invention to provide a virtual diagnostic test panel device, system and/or method which is adapted to use given test results from various diagnostic devices, systems and/or methods other than for the purpose that they were principally collected.

Prior attempts, if any, to solve problems associated with prior art diagnostic devices, systems, methods and/or computer readable media may have been unsuccessful and/or had one or more disadvantages associated with them. Prior art diagnostic devices, systems, methods and/or computer readable media may have been ill-suited to solve the stated problems and/or the shortcomings which have been associated with them.

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a system to virtually test for one or more diagnostic results in a biological or environmental subject. The system includes one or more databases and one or more processors. The databases include: a first test result collected from a first diagnostic test; and first quality control (QC) data associated with the first test result. They also include: a second test result collected from a second diagnostic test different than the first diagnostic test; and second QC data associated with the second test result. The databases also include one or more diagnostic matrices associated with the first diagnostic test, with the second diagnostic test, and with the biological or environmental subject. Each of the diagnostic matrices indicates at least a corresponding one of the diagnostic results. The processors are operatively encoded to automatically: apply a first interpretation algorithm to generate a first result coordinate based on the first test result; and apply a first QC protocol to generate a first QC coordinate based on the first QC data. They are also operatively encoded to automatically: apply a second interpretation algorithm to generate, based on the second test result, a second result coordinate on the same scale as the first result coordinate; and apply a second QC protocol to generate, based on the second QC data, a second QC coordinate on the same scale as the first QC coordinate. The processors are also operatively encoded to automatically: combine the first result coordinate, the first QC coordinate, the second result coordinate, and the second QC coordinate into a virtual test panel matrix; and when the virtual test panel matrix matches one or more of the diagnostic matrices, determine each aforesaid corresponding one of the diagnostic results which matches the virtual test panel matrix.

According to an aspect of one preferred embodiment of the invention, the first interpretation algorithm, the first QC protocol, the second interpretation algorithm, and/or the second QC protocol may preferably, but need not necessarily, be stored in the databases. Preferably before the first interpretation algorithm is applied as aforesaid, the first interpretation algorithm may preferably, but need not necessarily, be automatically retrieved from the databases. Preferably after the first QC data is associated with the first test result, the first QC protocol may preferably, but need not necessarily, be automatically retrieved from the databases and applied by the processors as aforesaid. Preferably before the second interpretation algorithm is applied as aforesaid, the second interpretation algorithm may preferably, but need not necessarily, be automatically retrieved from the databases. Preferably after the second QC data is associated with the second test result, the second QC protocol may preferably, but need not necessarily, be automatically retrieved from the databases and applied by the processors as aforesaid.

According to an aspect of one preferred embodiment of the invention, an update for at least one of the following may preferably, but need not necessarily, be delivered to and/or stored in the databases: the first interpretation algorithm; the first QC protocol; the second interpretation algorithm; and the second QC protocol.

According to an aspect of one preferred embodiment of the invention, the first interpretation algorithm and the first QC protocol may preferably, but need not necessarily, be adapted to generate the first result coordinate and/or the first QC coordinate as quantitative values or semi-quantitative values.

According to an aspect of one preferred embodiment of the invention, the aforesaid one or more of the diagnostic matrices may preferably, but need not necessarily, include at least a first range of accuracy for the first diagnostic test and/or a second range of accuracy for the second diagnostic test. The processors may preferably, but need not necessarily, automatically match the virtual test panel matrix with the aforesaid one or more of the diagnostic matrices, as aforesaid, when: (a) a first point, defined by the first result coordinate and the first QC coordinate, lies within the first range of accuracy; and/or (b) a second point, defined by the second result coordinate and the second QC coordinate, lies within the second range of accuracy.

According to an aspect of one preferred embodiment of the invention, the first range of accuracy and/or the second range of accuracy may preferably, but need not necessarily, be dependent on aggregated clinical data concerning the first point, the second point, and/or the corresponding one of the diagnostic results.

According to an aspect of one preferred embodiment of the invention, the first range of accuracy may preferably, but need not necessarily, be defined by minimum and/or maximum first result values matching the first result coordinate and/or by minimum and/or maximum first QC values matching the first QC coordinate. The second range of accuracy may preferably, but need not necessarily, be defined by minimum and/or maximum second result values matching the second result coordinate and/or by minimum and/or maximum second QC values matching the second QC coordinate.

According to an aspect of one preferred embodiment of the invention, the first test result may preferably, but need not necessarily, be clinical data stemming from a clinical examination.

According to an aspect of one preferred embodiment of the invention, the first test result and/or the first QC data may preferably, but need not necessarily, be collected using a diagnostic device.

According to an aspect of one preferred embodiment of the invention, the diagnostic device may preferably, but need not necessarily, be an auto-capture device which performs the first diagnostic test. The auto-capture device may preferably, but need not necessarily, automatically capture the first test result and/or the first QC data.

According to an aspect of one preferred embodiment of the invention, at least one of the databases may preferably, but need not necessarily, be remote from the diagnostic device. At least one of the processors may preferably, but need not necessarily, be local to the diagnostic device.

According to an aspect of one preferred embodiment of the invention, at least one of the databases may preferably, but need not necessarily, be local to the diagnostic device. At least one of the processors may preferably, but need not necessarily, be local to the diagnostic device.

According to an aspect of one preferred embodiment of the invention, the first QC data may preferably, but need not necessarily, include at least one of the following: one or more QC results for an assay associated with the first test result; one or more calibration results for the diagnostic device; one or more functional check results for the diagnostic device; and one or more QC results for a user associated with the first test result.

According to an aspect of one preferred embodiment of the invention, the first QC protocol may preferably, but need not necessarily, be dependent on at least one of the following: an assay associated with the first test result; the diagnostic device; and a user associated with the first test result.

According to an aspect of one preferred embodiment of the invention, the aforesaid one or more databases may preferably, but need not necessarily, include a database distributed over a network.

According to an aspect of one preferred embodiment of the invention, the aforesaid one or more databases may preferably, but need not necessarily, include at least two congruent databases.

According to an aspect of one preferred embodiment of the invention, the first interpretation algorithm may preferably, but need not necessarily, be dependent on at least one of the following: an age associated with the biological or environmental subject; a gender associated with the biological or environmental subject; a location associated with the biological or environmental subject; and a temperature associated with the biological or environmental subject.

According to the invention, there is also disclosed a method to virtually test for one or more diagnostic results in a biological or environmental subject. The method includes a database storage step of storing in one or more databases: a first test result collected from a first diagnostic test; first quality control (QC) data associated with the first test result; a second test result collected from a second diagnostic test different than the first diagnostic test; second QC data associated with the second test result; and one or more diagnostic matrices associated with the first diagnostic test, with the second diagnostic test, and with the biological or environmental subject. Each of the diagnostic matrices indicates at least a corresponding one of the diagnostic results. The method also includes a processing step of using one or more processors to automatically: apply a first interpretation algorithm to generate a first result coordinate based on the first test result; apply a first QC protocol to generate a first QC coordinate based on the first QC data; apply a second interpretation algorithm to generate, based on the second test result, a second result coordinate on the same scale as the first result coordinate; apply a second QC protocol to generate, based on the second QC data, a second QC coordinate on the same scale as the first QC coordinate; combine the first result coordinate, the first QC coordinate, the second result coordinate, and the second QC coordinate into a virtual test panel matrix; and when the virtual test panel matrix matches one or more of the diagnostic matrices, determine each aforesaid corresponding one of the diagnostic results which matches the virtual test panel matrix.

According to an aspect of one preferred embodiment of the invention, preferably in the database storage step, the first interpretation algorithm, the first QC protocol, the second interpretation algorithm, and/or the second QC protocol may preferably, but need not necessarily, be stored in the databases. Preferably before the processing step, the first interpretation algorithm may preferably, but need not necessarily, be automatically retrieved from the databases. Preferably after the database storage step, the first QC protocol may preferably, but need not necessarily, be automatically retrieved from the databases and applied by the processors as aforesaid. Preferably before the processing step, the second interpretation algorithm may preferably, but need not necessarily, be automatically retrieved from the databases. Preferably after the database storage step, the second QC protocol may preferably, but need not necessarily, be automatically retrieved from the databases and applied by the processors as aforesaid.

According to an aspect of one preferred embodiment of the invention, preferably in the database storage step, an update for at least one of the following may preferably, but need not necessarily, be delivered to and/or stored in the databases: the first interpretation algorithm; the first QC protocol; the second interpretation algorithm; and the second QC protocol.

According to an aspect of one preferred embodiment of the invention, the first interpretation algorithm and/or the first QC protocol may preferably, but need not necessarily, be adapted to generate, preferably in the processing step, the first result coordinate and/or the first QC coordinate as quantitative values or semi-quantitative values.

According to an aspect of one preferred embodiment of the invention, preferably in the database storage step, the aforesaid one or more of the diagnostic matrices may preferably, but need not necessarily, include at least a first range of accuracy for the first diagnostic test and/or a second range of accuracy for the second diagnostic test. In the processing step, the processors may preferably, but need not necessarily, automatically match the virtual test panel matrix with the aforesaid one or more of the diagnostic matrices, as aforesaid, when: (a) a first point, defined by the first result coordinate and the first QC coordinate, lies within the first range of accuracy; and/or (b) a second point, defined by the second result coordinate and the second QC coordinate, lies within the second range of accuracy.

According to an aspect of one preferred embodiment of the invention, preferably before the processing step, the first range of accuracy and/or the second range of accuracy may preferably, but need not necessarily, be determined in dependent relation on aggregated clinical data concerning the first point, the second point, and/or the corresponding one of the diagnostic results.

According to an aspect of one preferred embodiment of the invention, preferably before the processing step: the first range of accuracy may preferably, but need not necessarily, be defined by minimum and/or maximum first result values matching the first result coordinate and/or by minimum and/or maximum first QC values matching the first QC coordinate; and/or the second range of accuracy may preferably, but need not necessarily, be defined by minimum and/or maximum second result values matching the second result coordinate and/or by minimum and/or maximum second QC values matching the second QC coordinate.

According to an aspect of one preferred embodiment of the invention, preferably in the database storage step, the first test result may preferably, but need not necessarily, be clinical data stemming from a clinical examination, preferably before the database storage step.

According to an aspect of one preferred embodiment of the invention, the method may preferably, but need not necessarily, also include a result collection step, preferably before the database storage step, wherein the first test result and/or the first QC data may preferably, but need not necessarily, be collected using a diagnostic device.

According to an aspect of one preferred embodiment of the invention, the diagnostic device may preferably, but need not necessarily, be an auto-capture device which performs the first diagnostic test. Preferably in the result collection step, the auto-capture device may preferably, but need not necessarily, automatically capture the first test result and/or the first QC data.

According to an aspect of one preferred embodiment of the invention, preferably in the database storage step, at least one of the databases may preferably, but need not necessarily, be remote from the diagnostic device. Preferably in the processing step, at least one of the processors may preferably, but need not necessarily, be local to the diagnostic device.

According to an aspect of one preferred embodiment of the invention, preferably in the database storage step, at least one of the databases may preferably, but need not necessarily, be local to the diagnostic device. Preferably in the processing step, at least one of the processors may preferably, but need not necessarily, be local to the diagnostic device.

According to an aspect of one preferred embodiment of the invention, preferably in the database storage step, the first QC data may preferably, but need not necessarily, include at least one of the following: one or more QC results for an assay associated with the first test result; one or more calibration results for the diagnostic device; one or more functional check results for the diagnostic device; and one or more QC results for a user associated with the first test result.

According to an aspect of one preferred embodiment of the invention, preferably in the processing step, the first QC protocol may preferably, but need not necessarily, be dependent on at least one of the following: an assay associated with the first test result; the diagnostic device; and a user associated with the first test result.

According to an aspect of one preferred embodiment of the invention, preferably in the database storage step, the aforesaid one or more databases may preferably, but need not necessarily, include a database distributed over a network.

According to an aspect of one preferred embodiment of the invention, preferably in the database storage step, the aforesaid one or more databases may preferably, but need not necessarily, include at least two congruent databases.

According to an aspect of one preferred embodiment of the invention, preferably in the processing step, the first interpretation algorithm may preferably, but need not necessarily, be dependent on at least one of the following: an age associated with the biological or environmental subject; a gender associated with the biological or environmental subject; a location associated with the biological or environmental subject; and a temperature associated with the biological or environmental subject.

According to the invention, there is also disclosed a computer readable medium on which is stored instructions. Upon execution the instructions will operate a system to virtually test for one or more diagnostic results in a biological or environmental subject. The instructions include instructions for storing in one or more databases: a first test result collected from a first diagnostic test; first quality control (QC) data associated with the first test result; a second test result collected from a second diagnostic test different than the first diagnostic test; second QC data associated with the second test result; and one or more diagnostic matrices associated with the first diagnostic test, with the second diagnostic test, and with the biological or environmental subject. Each of the diagnostic matrices indicates at least a corresponding one of the diagnostic results. The instructions also include instructions for using one or more processors to automatically: apply a first interpretation algorithm to generate a first result coordinate based on the first test result; apply a first QC protocol to generate a first QC coordinate based on the first QC data; apply a second interpretation algorithm to generate, based on the second test result, a second result coordinate on the same scale as the first result coordinate; apply a second QC protocol to generate, based on the second QC data, a second QC coordinate on the same scale as the first QC coordinate; combine the first result coordinate, the first QC coordinate, the second result coordinate, and the second QC coordinate into a virtual test panel matrix; and when the virtual test panel matrix matches one or more of the diagnostic matrices, determine each said corresponding one of the diagnostic results which matches the virtual test panel matrix.

According to the invention, there is also disclosed a device to virtually test for one or more diagnostic results in a biological or environmental subject. The device includes an auto-capture module which automatically captures: a first test result from a first diagnostic test; and first quality control (QC) data associated with the first test result. It also includes at least one memory locally storing: the first test result and the first QC data; a virtual test panel matrix; and one or more diagnostic matrices. The virtual test panel matrix includes: a second result coordinate based on a second test result collected from a second diagnostic test different than the first diagnostic test; and a second QC coordinate based on second QC data associated with the second test result. The diagnostic matrices are associated with the first diagnostic test, with the second diagnostic test, and with the biological or environmental subject. Each of the diagnostic matrices indicates at least a corresponding one of the diagnostic results. The device also includes one or more processors operatively encoded to automatically: apply a first interpretation algorithm to generate, based on the first test result, a first result coordinate on the same scale as the second result coordinate; and apply a first QC protocol to generate, based on the first QC data, a first QC coordinate on the same scale as the second QC coordinate. The processors are also operatively encoded to automatically: integrate the first result coordinate and the first QC coordinate into the virtual test panel matrix; and when the virtual test panel matrix matches one or more of the diagnostic matrices, determine each aforesaid corresponding one of the diagnostic results which matches the virtual test panel matrix.

According to an aspect of one preferred embodiment of the invention, the device may preferably, but need not necessarily, be adapted for use with one or more databases. The first interpretation algorithm and/or the first QC protocol may preferably, but need not necessarily, be stored in the databases. Preferably before the first interpretation algorithm is applied as aforesaid, the first interpretation algorithm may preferably, but need not necessarily, be automatically retrieved from the databases. Preferably after the first QC data is associated with the first test result, the first QC protocol may preferably, but need not necessarily, be automatically retrieved from the databases.

According to an aspect of one preferred embodiment of the invention, at least one of the databases may preferably, but need not necessarily, be remote from the device.

According to an aspect of one preferred embodiment of the invention, the device may preferably, but need not necessarily, also include a communication element which may preferably, but need not necessarily, deliver an update for the first interpretation algorithm and/or the first QC protocol, preferably for storage in the databases.

According to an aspect of one preferred embodiment of the invention, the memory may preferably, but need not necessarily, store at least one of the databases.

According to an aspect of one preferred embodiment of the invention, the first interpretation algorithm and the first QC protocol may preferably, but need not necessarily, be adapted so the processors generate the first result coordinate and/or the first QC coordinate as quantitative values or semi-quantitative values.

According to an aspect of one preferred embodiment of the invention, the aforesaid one or more of the diagnostic matrices may preferably, but need not necessarily, include at least a first range of accuracy for the first diagnostic test and/or a second range of accuracy for the second diagnostic test. The processors may preferably, but need not necessarily, automatically match the virtual test panel matrix with said one or more of the diagnostic matrices, as aforesaid, when: (a) a first point, defined by the first result coordinate and the first QC coordinate, lies within the first range of accuracy; and/or (b) a second point, defined by the second result coordinate and the second QC coordinate, lies within the second range of accuracy.

According to an aspect of one preferred embodiment of the invention, the first range of accuracy and/or the second range of accuracy may preferably, but need not necessarily, be dependent on aggregated clinical data concerning the first point, the second point, and/or the corresponding one of the diagnostic results.

According to an aspect of one preferred embodiment of the invention, the first range of accuracy may preferably, but need not necessarily, be defined by minimum and/or maximum first result values matching the first result coordinate and/or by minimum and/or maximum first QC values matching the first QC coordinate. The second range of accuracy may preferably, but need not necessarily, be defined by minimum and/or maximum second result values matching the second result coordinate and/or by minimum and/or maximum second QC values matching the second QC coordinate.

According to an aspect of one preferred embodiment of the invention, the first QC data may preferably, but need not necessarily, include at least one of the following: one or more QC results for an assay associated with the first test result; one or more calibration results for the device; one or more functional check results for the device; and one or more QC results for a user associated with the first test result.

According to an aspect of one preferred embodiment of the invention, the first QC protocol may preferably, but need not necessarily, be dependent on at least one of the following: an assay associated with the first test result; the device; and a user associated with the first test result.

According to an aspect of one preferred embodiment of the invention, the first interpretation algorithm may preferably, but need not necessarily, be dependent on at least one of the following: an age associated with the biological or environmental subject; a gender associated with the biological or environmental subject; a location associated with the biological or environmental subject; and a temperature associated with the biological or environmental subject.

Other advantages, features and/or characteristics of the present invention, as well as methods of operation and/or functions of the related elements of the device, system, method and computer readable medium, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method, device and computer readable medium according to the present invention, as to their structure, organization, use, and/or method of operation, together with further objectives and/or advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram depicting a virtual test panel system according to one preferred embodiment of the invention;

FIG. 2 is a schematic diagram depicting generation of coordinates for a point in a virtual test panel matrix of the system of FIG. 1;

FIGS. 3A to 3F are schematic diagrams depicting ranges of accuracy for two diagnostic tests on diagnostic matrices of the system of FIG. 1;

FIG. 4 is a further schematic diagram depicting further ranges of accuracy for the aforesaid two diagnostic tests on a further diagnostic matrix of the system of FIG. 1; and

FIG. 5 is a schematic diagram depicting elements of and/or for use with the system of FIG. 1, including an auto-capture virtual test device according to one preferred embodiment of the invention.

### DETAILED DESCRIPTION OF THE PREFERRED EMBODIMENTS

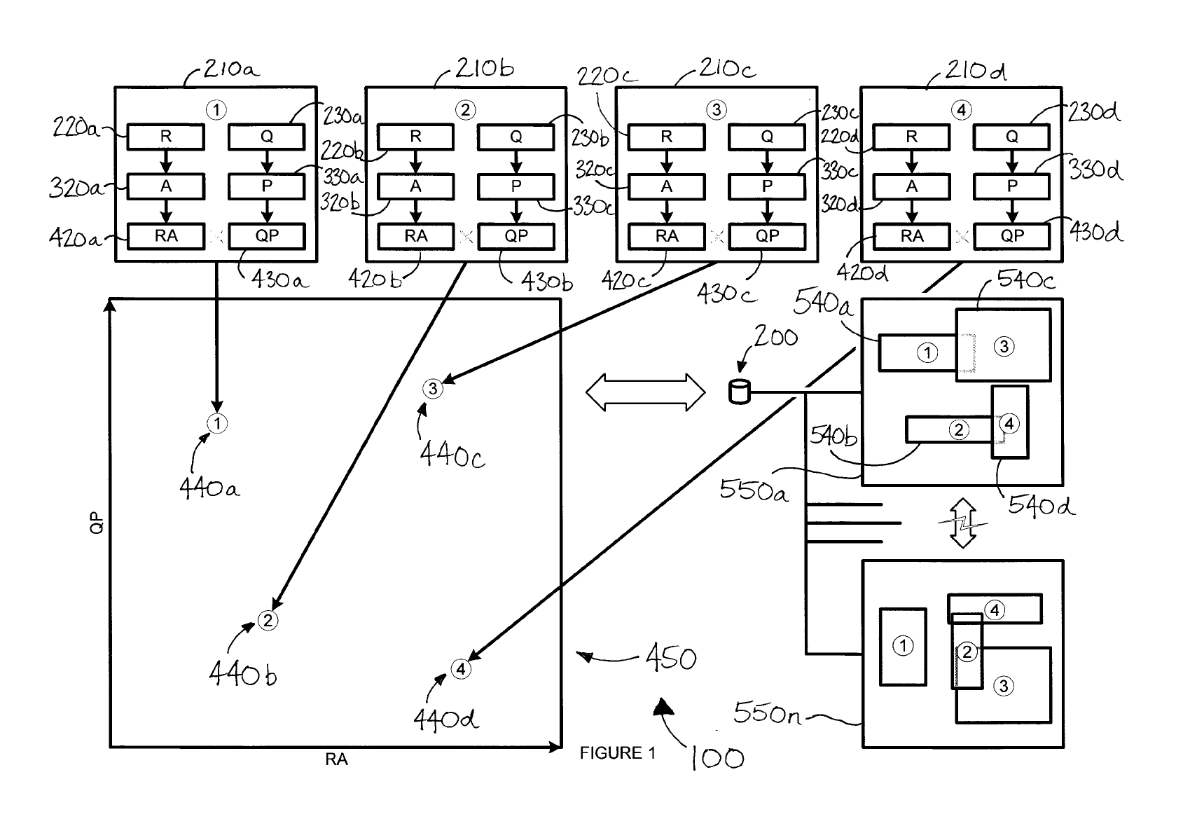

Referring now to FIG. 1 of the drawings, there is generally depicted a schematic diagram of a system 100 according to a preferred embodiment of the present invention.

FIG. 1 depicts first, second, third and fourth diagnostic tests 210a, 210b, 210c, 210d (alternately, referenced by numerals “210a-d” or simply “210”). The first, second, third and fourth diagnostic tests 210a-d are associated with respectively corresponding first, second, third and fourth test results 220a, 220b, 220c, 220d (alternately, referenced herein by numerals “220a-d” or simply “220”) and first, second, third and fourth quality control (“QC”) data 230a, 230b, 230c, 230d (alternately, referenced herein by numerals “230a-d” or simply “230”). FIG. 1 shows that respectively corresponding first, second, third and fourth interpretation algorithms 320a, 320b, 320c, 320d (alternately, referenced herein by numerals “320a-d” or simply “320”) are applied to the first, second, third and fourth test results 220a-d. Respectively corresponding first, second, third and fourth QC protocols 330a, 330b, 330c, 330d (alternately, referenced herein by numerals “330a-d” or simply “330”) are applied to the first, second, third and fourth sets of QC data 230a-d. The interpretation algorithms 320a-d and the QC protocols 330a-d are applied as aforesaid and as appropriate in the circumstances and given the nature of each test result 220a-d and the circumstances of its respective collection. In this manner, first, second, third and fourth result coordinates 420a, 420b, 420c, 420d (alternately, referenced herein by numerals “420a-d” or simply “420”) and respectively corresponding first, second, third and fourth QC coordinates 430a, 430b, 430c, 430d (alternately, referenced herein by numerals “430a-d” or simply “430”) are respectively generated for the test results 220a-d and their corresponding sets of QC data 230a-d.

To put it another way, more generally, FIG. 1 depicts tests 210 associated with corresponding test results 220 and QC data 230. Interpretation algorithms 320 (“A”) are applied to corresponding test results 220 (“R”) to generate result coordinates 420 (“RA”). And, QC protocols 330 (“P”) are applied to corresponding QC data 230 (“Q”) to generate QC coordinates 430 (“QP”).

The result coordinate 420 and QC coordinate 430 for each result 220 and its QC data 230 preferably, when taken together, define first, second, third and fourth points 440a, 440b, 440c, 440d (alternately, referenced herein by numerals “440a-d” or simply “440”) that may be plotted to generate a virtual test panel matrix 450, as shown in FIG. 1.

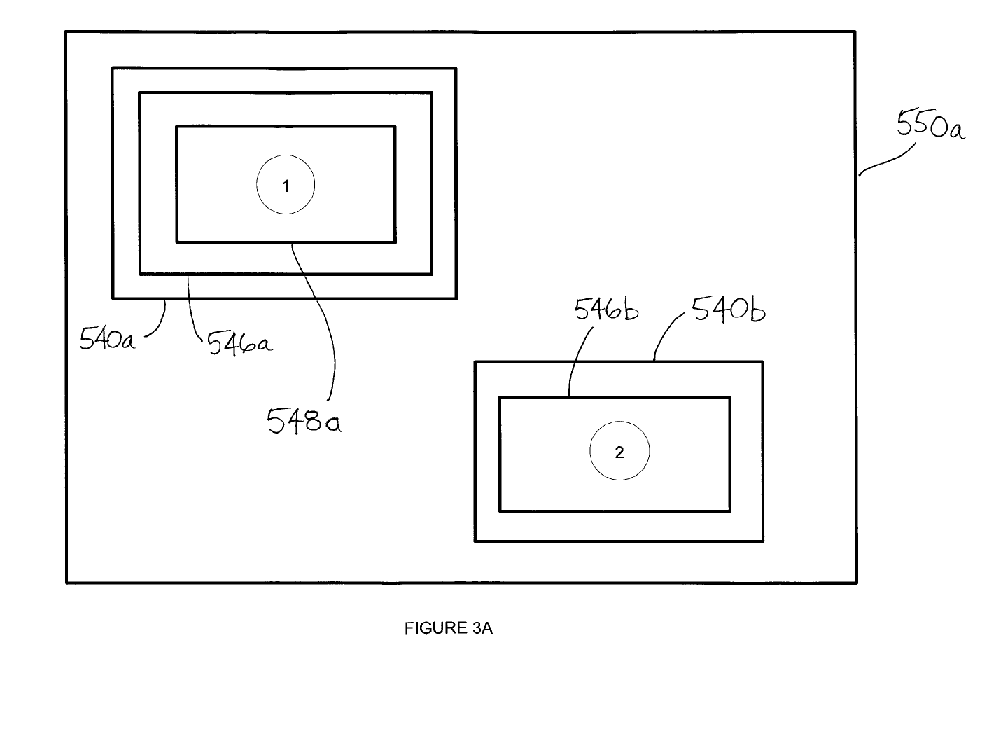

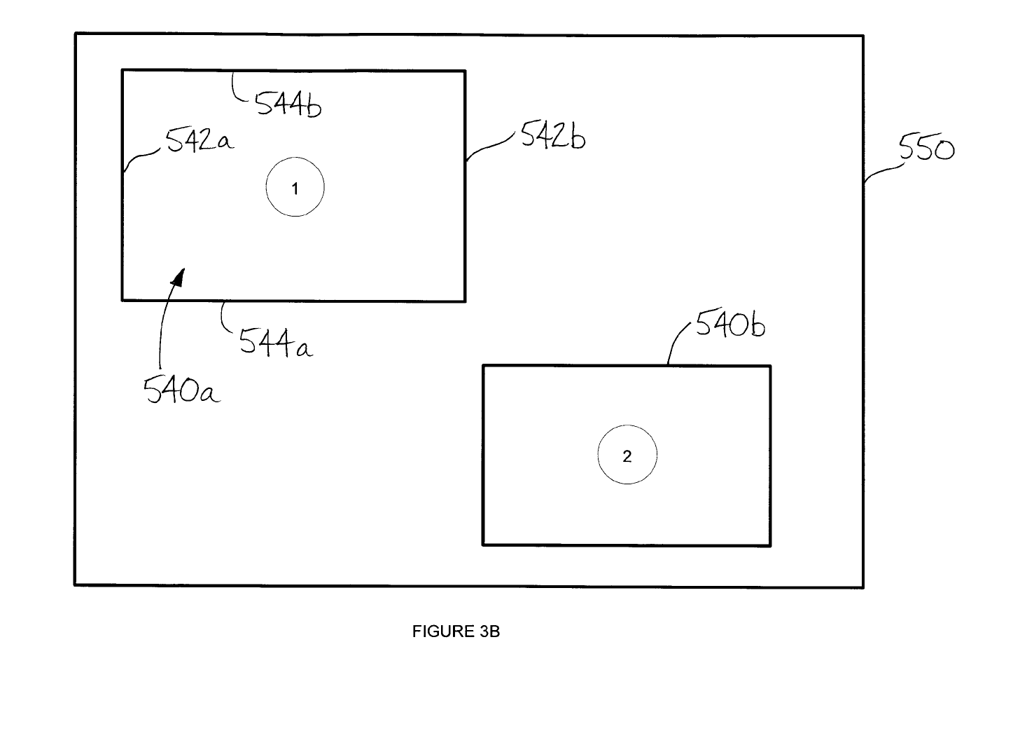

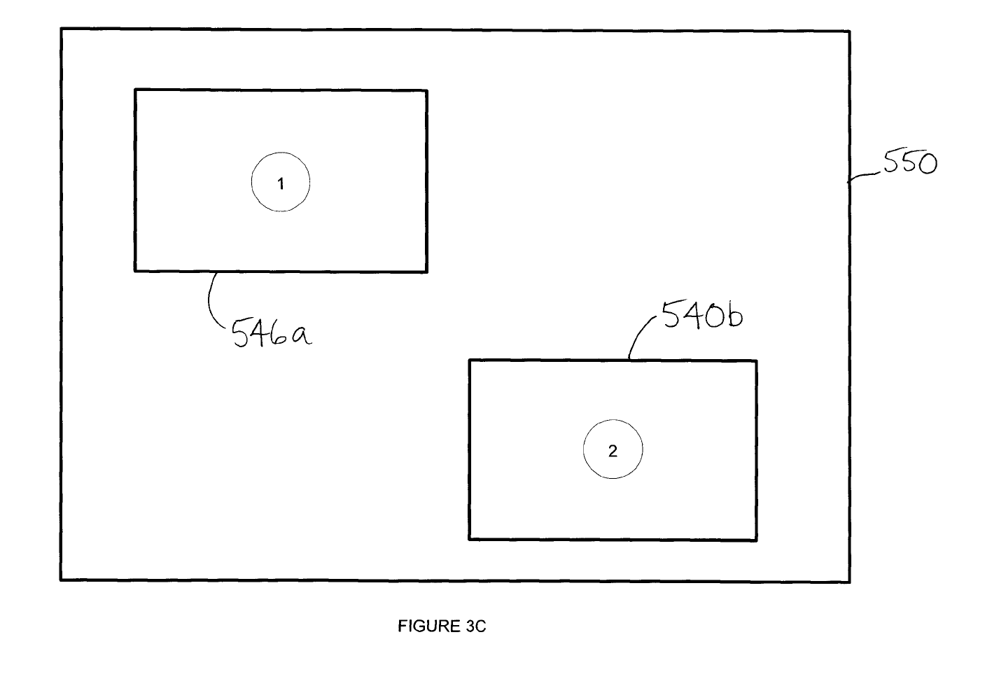

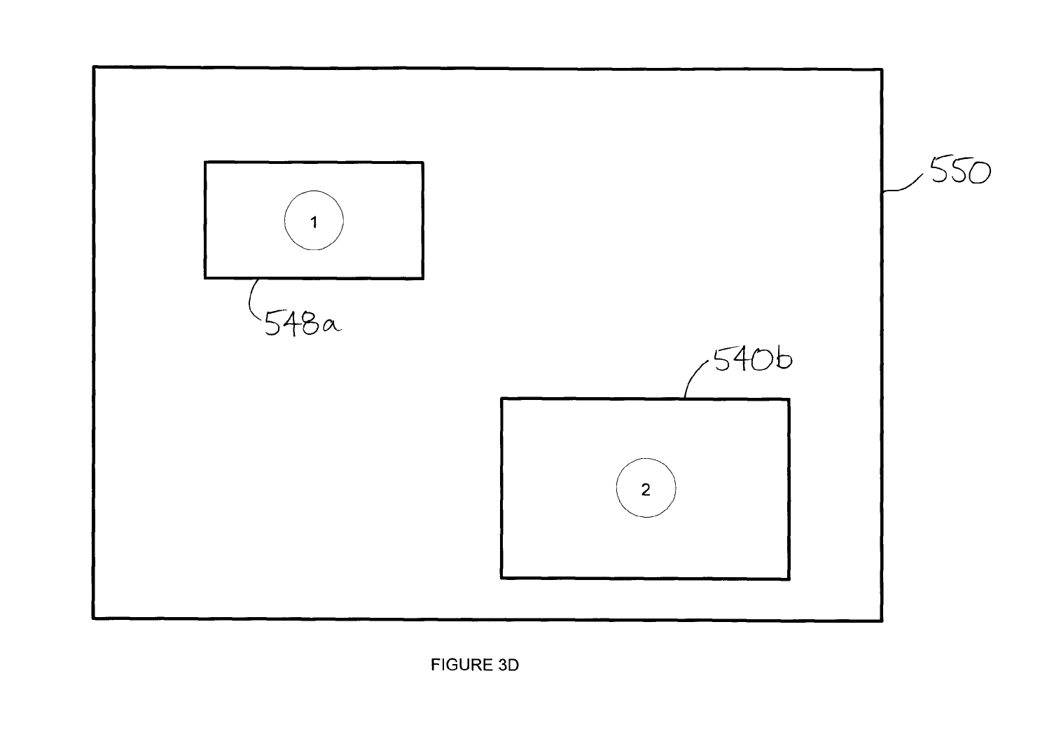

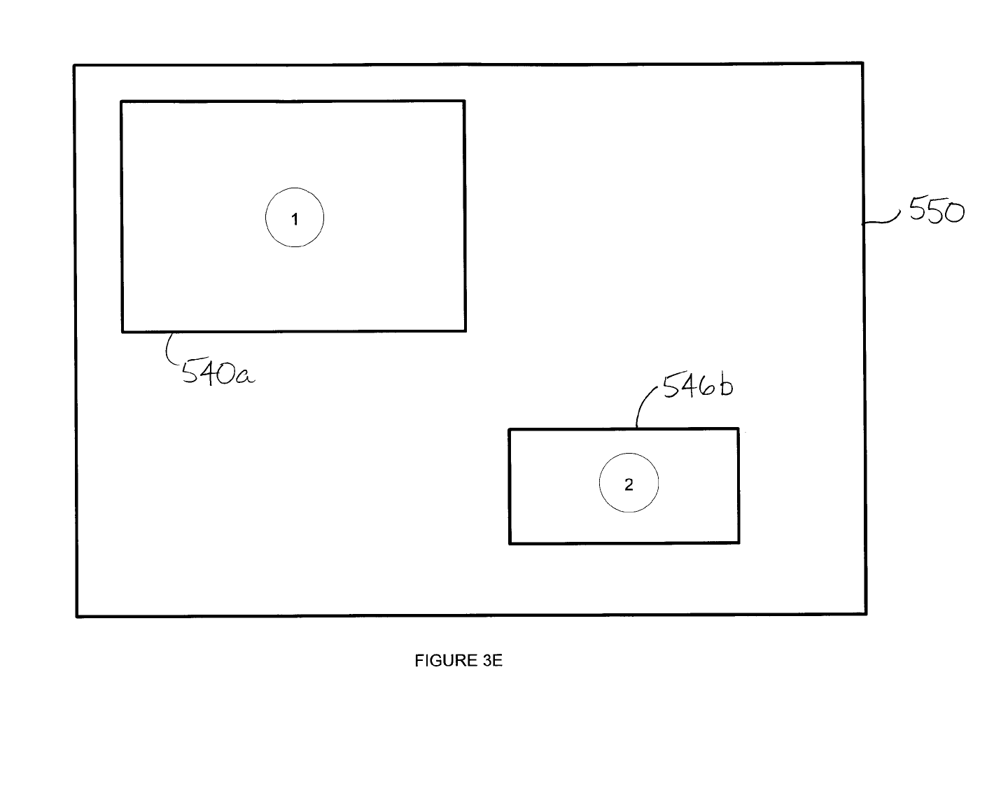

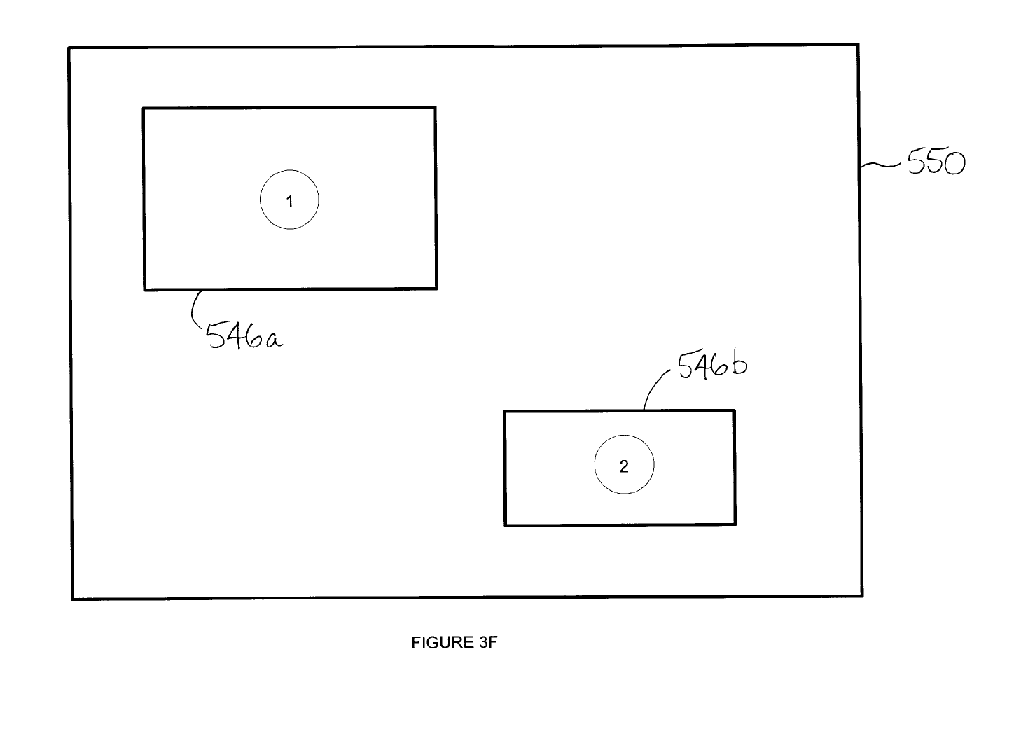

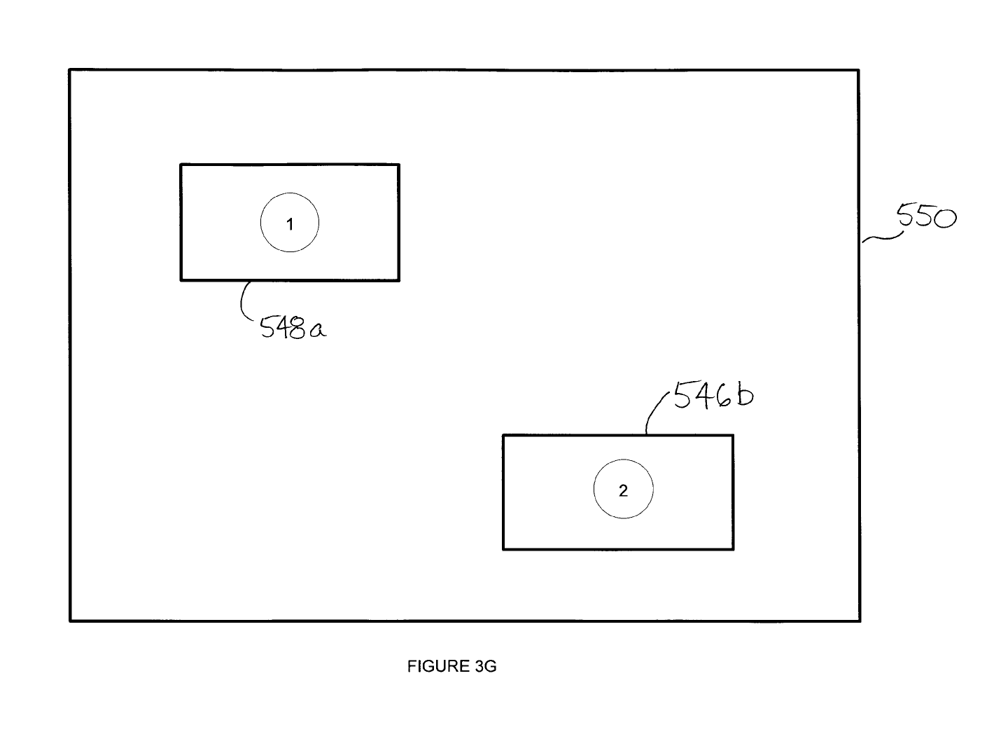

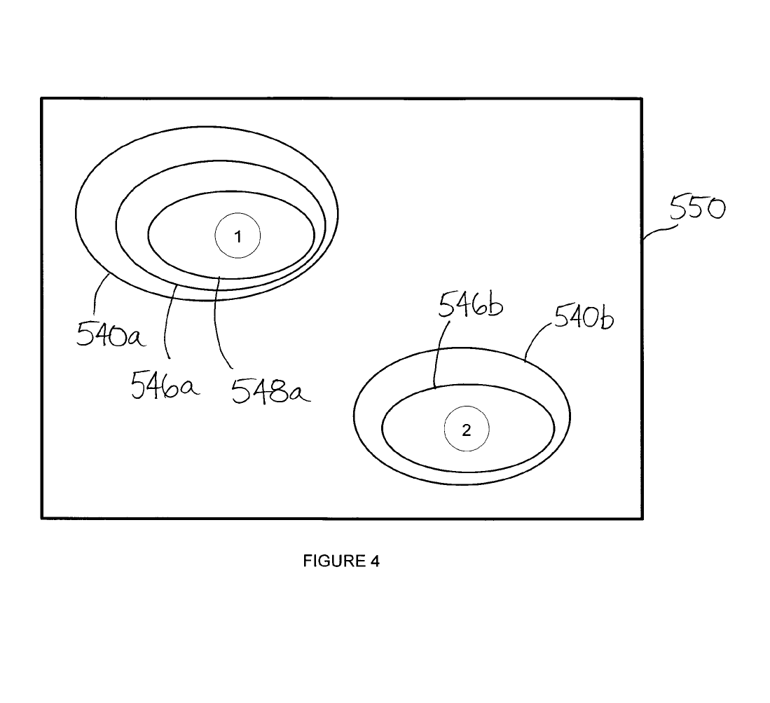

FIG. 1 schematically depicts that the virtual test panel matrix 450 is preferably, according to the invention, compared against one or more diagnostic matrices 550a-550n (alternately, referenced herein by numerals “550a-n” or simply “550”) for a potential match. Databases 200 preferably include various diagnostic matrices 550, each representing and/or corresponds with a particular positive diagnostic result. As shown in FIG. 1, each of the diagnostic matrices 550 preferably includes two or more regions (alternately, referenced herein as “ranges”) of accuracy 540a, 540b, 540c, 540d (alternately, referenced herein by numerals “540a-d” or simply “540”), each for comparison against one of the points 440 in the virtual test panel matrix 450. Similarly, FIGS. 3A to 4 show diagnostic matrices 550 which include two or more regions of accuracy 540, each for comparison against one of the points 440 in the virtual test panel matrix 450.

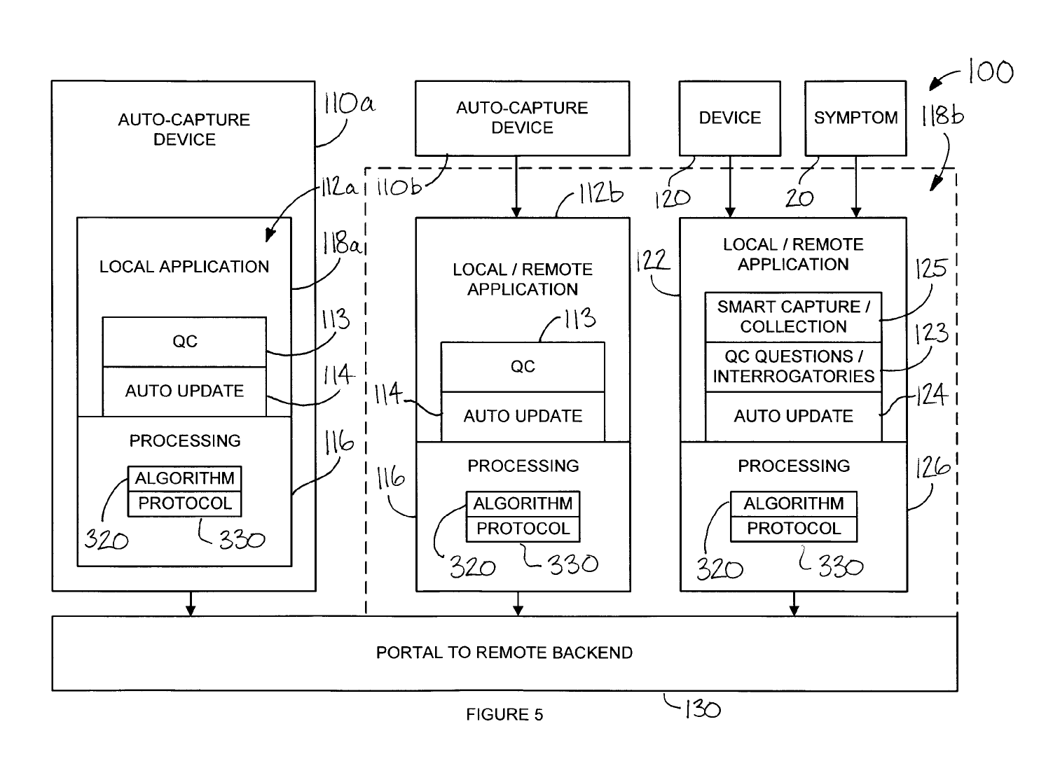

Preferably, one or more processors 116, 126 (such as those shown in FIG. 5) automatically compare the virtual test panel matrix 450 against the diagnostic matrices 550 for a potential match. In doing so, the processors 116, 126 determine if a corresponding point 440 in the virtual test panel matrix 450 lies within each range of accuracy 540 in a particular diagnostic matrix 550. If so, the diagnostic matrix 550 is determined to match the virtual test panel matrix 450 (and/or vice versa). Each of the diagnostic results corresponding to the matching diagnostic matrices 550 may then be presented to a user and/or associated with the biological or environmental subject.

### EXAMPLES

It may be worthwhile, for the purposes of illustration, to detail this process by way of the following non-limiting example. The following paragraphs set out an example, without intending to be bound by theory or hypothesis, in reference to FIG. 1. (Persons having ordinary skill in the art should appreciate that FIG. 1 may in addition or instead relate to numerous other real situations and examples.)

In this example, the first test result 220a is taken from a first diagnostic test 210a in the form of a genetic assay for gene X. In this example, the genetic assay is performed on a blood sample using an auto-capture device 110a, such as that which is depicted in FIG. 5. QC data 230a may account for device conditions and blood sample characteristics associated with the test 210a which, for example, may have been less than ideal.

The second test result 220b is taken from a second diagnostic test 210b in the form of a biopsy (e.g., assay of a tissue sample collected by a surgeon and performed by a pathologist). QC data 230b may account for collection techniques and sample handling associated with the test 210b which, for example, may have been less than ideal.

The third test result 220c is taken from a third diagnostic test 210c for pesticide Y. In this example, the test 210c is performed on a hair sample using an auto-capture device 110b, such as that which is depicted in FIG. 5. QC data 230c may account for hair sample characteristics associated with the test 210c which, for example, may have been less than ideal.

The fourth test result 220d is taken from a fourth diagnostic test 210d in the form of an imaging assay (e.g., performed on tissue in situ). QC data 230d may account for device conditions and imaging techniques associated with the test 210d which, for example, may have been less than ideal.

In this example, the test results 220a-d are notionally taken from four different tests 210a-d. The results 220a-d and their corresponding sets of QC data 230a-d may be provided as numerical values.

On the other hand, one or more of the test results 220a-d and the corresponding QC data 230a-d may be provided, in whole or in part, as non-numerical values—e.g., as qualitative and/or semi-quantitative values. In another example, some results 220 may be colors (e.g., “Red”, “Green” or “Blue”), and some QC data 230 may include semi-quantitative confidence values (e.g., “Poor”, “Fair” or “Good”). If the results 220 or the QC data 230 include non-numerical values, the interpretation algorithms 320 and the QC protocols 330 may preferably, among other things, convert them into numerical values.

Persons having ordinary skill in the art will appreciate, in view of the disclosures herein, that there will be many different ways (arbitrary and otherwise) within the scope of the present invention to convert non-numerical values into numerical ones. The following couple of additional examples may help to illustrate this point: (I) colors may be converted into numerical values based on their brightness and/or position(s) on the electromagnetic spectrum; and (II) semi-quantitative values may be assigned relative numerical values along an arbitrary number scale, e.g., “Poor”=1, “Fair”=2, and “Good”=3.

Whether or not the results 220 and the QC data 230 are originally provided as numerical values, or converted into them, the result 220 and QC data 230 numerical values may be provided in units which bear little resemblance or overlap with, or are on a fundamentally different scale or order of magnitude than, those of various others. The interpretation algorithms 320 and QC protocols 330 preferably also allow each result 220 and QC data 230 to be mapped on the same axes and at the same scale, and/or generally in the same order of magnitude, as each of the others.

Persons having ordinary skill in the art will appreciate, in view of the disclosures herein, that there will be many different ways within the scope of the present invention to convert different numerical values so that they may be plotted on the same scale. For example, with reference to a range of potential results 220a-d for given tests 210a-d, each numerical value result may be converted into a number between zero (0) and one (1).

In our example, the results 220 and QC data 230 may be processed by the appropriate interpretation algorithms 320 and QC protocols 330 to give the result and QC coordinates 420, 430 which are set out in below Table 1 (corresponding, for example, with the points 440a-d depicted in FIG. 1). Each result coordinate 420a-d may be plotted against its corresponding QC coordinate 430a-d to define a point 440a-d. The points 440a-d are then plotted to generate a combined virtual panel matrix 450 (as in FIG. 1):

TABLE 1

| | Result | QC |
|---|---|---|
| | Coordinate 420 | Coordinate 430 |
| 1^{st} Test 210a | 0.23 | 0.72 |
| 2^{nd} Test 210b | 0.35 | 0.28 |
| 3^{rd} Test 210c | 0.71 | 0.80 |
| 4^{th} Test 210d | 0.78 | 0.17 |

By way of interpretation, the first test 210a may for example reveal that 23% of the tested cells possessed gene X (i.e., corresponding to a first result coordinate 420a of 0.23), with a 0.72 QC score (i.e., corresponding to a first QC coordinate 430a of 0.72). With a second QC coordinate 430b of 0.28, the exemplary second test 210b may indicate a second result coordinate of 0.35 on an example biopsy scale where abnormal cancerous cells could have a biopsy score anywhere between 0.15 and 0.64. As a further example, with a third QC coordinate 430c of 0.80, the third test 210c may indicate pesticide Y levels at 71% of a maximum pesticide Y value (i.e., a third result coordinate 420c of 0.71) which may be detected using that auto-capture device 110b (as shown in FIG. 5) on a hair sample. Last, with a fourth QC coordinate 430d of 0.17, the example test 210d may indicate tissue densities at 78% of a maximum density (i.e., a fourth result coordinate 420d of 0.78) which may be detected using that imaging technology.

These four processed result coordinates 420a-d and QC coordinates 430a-d then may be virtually assembled, according to the invention, from their four different tests 210a-d into points 440a-d to generate a single/combined virtual panel matrix 450. The combined virtual panel matrix 450 may be so assembled with the aim of diagnosing the presence or existence of any of a plurality of different conditions, characteristics, states, agents (e.g., pathogens) and/or markers in the associated biological and/or environmental test subjects. The combined virtual panel matrix 450 is then compared against one or more databases 200 for a potential match amongst a variety of diagnostic matrices 550, each of which represents and/or corresponds with a particular positive diagnostic result. Each of the diagnostic matrices 550 may include one or more regions of accuracy 540.

Continuing with the above example, the test results 220 and their corresponding QC data 230 are preferably, according to the invention, most closely linked with a particularly well matching diagnostic matrix 550a which, e.g., may represent and correspond with a positive diagnosis for a particular cancer, namely, cancer Z₀. The matching diagnostic matrix 550a of this example is alternately herein referenced as the “Cancer Z₀ Diagnostic Matrix” 550a.

Theoretically and/or by way of one or more hypotheses, the ranges of accuracy 540 for each of the diagnostic tests 210 in the Cancer Z₀ Diagnostic Matrix 550a preferably may be understandable, for example, as set out in the following paragraphs:

First Diagnostic Test 210a:

When the first test result 220a shows that more than about 38% of the tested cells possess gene X (i.e., which corresponds to a first result coordinate 420a of 0.38), cancer Z₁ typically may be indicated, instead of cancer Z₀. When less than about 10% of the tested cells possess gene X (i.e., which corresponds to a first result coordinate 420a of 0.10), neither cancer Z₀ nor cancer Z₁ typically may be indicated. First QC coordinates 430a of less than about 0.67 in association with the first test 210a may be insufficiently reliable to have predictive value. First QC coordinates 430a greater than about 0.84 in association with the first test 210a may not be possible given certain limitations of the auto-capture device 110a to test blood samples for gene X. Thus, when between about 10% and about 38% of the tested cells possess gene X (i.e., first result coordinate 420a), and first QC coordinates 430a between about 0.67 and 0.84 are achieved, cancer Z₀ typically may be indicated when other points 440b, 440c, 440d of the virtual test panel matrix 450 also fall within their corresponding regions of accuracy 540b, 540c, 540d on the Cancer Z₀ Diagnostic Matrix 550a.

Second Diagnostic Test 210b:

When the second test result 220b (the biopsy) leads to a second result coordinate 420b that is greater than about 0.64, cells may be indicated as abnormal but non-cancerous. When the second result coordinate 420b is less than about 0.15, cells may be indicated as non-viable (e.g., not even as a cancer). Second QC coordinates 430b that are less than about 0.20 for the second test 210b may be insufficiently reliable to have predictive value. Second QC coordinates 430b that are greater than about 0.33 may not be possible given certain limitations to the collection and sample handling methods of the second test 210b. Thus, when the second result coordinates 420b are between about 0.15 and about 0.64, and second QC coordinates 430b of between about 0.20 and 0.33 are achieved, cancer Z₀ typically may be indicated when other points 440a, 440c, 440d of the virtual test panel matrix 450 also fall within their corresponding regions of accuracy 540a, 540c, 540d on the Cancer Z₀ Diagnostic Matrix 550a.

Third Diagnostic Test 210c:

When the third test result 220c shows that a pesticide Y level (i.e., the third result coordinate 420c) is greater than about 95% of the maximum detectable, death may be indicated. When the third test result 220c shows that pesticide Y levels are less than about 50% of the maximum detectable, the subject may not be associated with cancer Z₀. Third QC coordinates 430c that are less than about 0.60 for the third diagnostic test 210c may be insufficiently reliable to have predictive value. Third QC coordinates 430c greater than about 0.95 may not be possible given certain limitations of the auto-capture device 110a to test hair samples for pesticide Y. Thus, when pesticide Y levels (i.e., third result coordinates 420c) are between about 50% and about 95% of the maximum detectable, and third QC coordinates 430c of between about 0.60 and 0.95 are achieved, cancer Z₀ typically may be indicated when other points 440a, 440b, 440d of the virtual test panel matrix 450 also fall within their corresponding regions of accuracy 540a, 540b, 540d on the Cancer Z₀ Diagnostic Matrix 550a.

Fourth Diagnostic Test 210d:

When the fourth test result 220d shows tissue densities (i.e., fourth result coordinates 420d) greater than about 85% of the maximum detectable, the tissues may be too dense to yield meaningful test results 220d. Tissue densities less than about 62% of the maximum detectable may indicate a normal tissue density. Fourth QC coordinates 430d that are less than about 0.15 on the fourth test 210d may be insufficiently reliable to have predictive value. QC scores greater than about 0.45 may not be possible given certain limitations to the type and model of the device 120 used for the fourth test 210d. Thus, when tissue densities (i.e., fourth result coordinates 420d) are between about 62% and about 85% of the maximum detectable, and fourth QC coordinates 430d between about 0.15 and 0.45 are achieved, cancer Z₀ typically may be indicated when other points 440a, 440b, 440c of the virtual test panel matrix 450 also fall within their corresponding regions of accuracy 540a, 540b, 540c on the Cancer Z0 Diagnostic Matrix 550a.

### Further Detailed Description of the Preferred Embodiments

The virtual test panel matrix 450 is preferably dependent on test results 220, interpretation algorithms 320, QC data 230 (e.g., device calibration and/or functional check results, user QC results), and QC protocols 330 (e.g., regarding test assays, devices and users).

Preferably, the device 110a, system 100, method and computer readable medium according to the invention broadly involve and/or are associated with identification of the result and QC coordinates 420, 430.

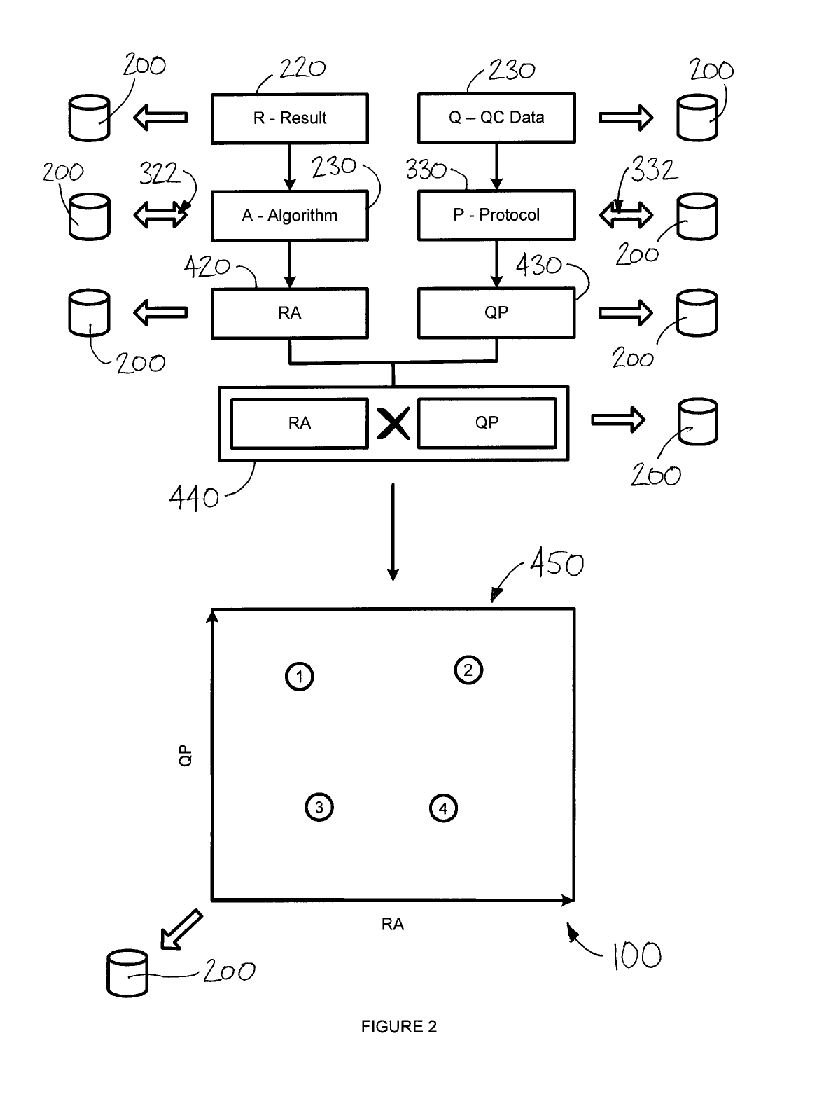

According to the present invention, and as depicted in FIG. 2, the results 220, QC data 230, interpretation algorithms 320, QC protocols 330, result coordinates 420, QC coordinates 430, points 440, and virtual test panel matrices 450 may be stored in the databases 200. Each test result 220 is preferably associated with corresponding ones of the interpretation algorithms 320, QC data 230 and QC protocols 330. Preferably, according to the present invention, updates 322 to the interpretation algorithms 320 and QC protocols 330 may be obtained from and/or delivered to the databases 200. The databases 200 may include one or more local, remote, distributed and/or congruent databases.

FIG. 3A shows a diagnostic matrix 550 which includes: three ranges of accuracy 540a, 546a, 548a associated with the first point 440a (and with the first diagnostic test 210a); and two ranges of accuracy 540b, 546b associated with the second point 440b (and with the second diagnostic test 210b). Arbitrarily, for example, the three regions of accuracy 540a, 546a, 548a depicted for the first diagnostic test 210a may be ˜50%, ˜75%, and ˜100% respectively. The two regions of accuracy 540b, 546b for the second diagnostic test 210b may be ˜50% and ˜100% respectively. When the first and second points 440a, 440b fall within the boundaries of the most restrictive ranges of accuracy 548a, 546b shown in the FIG. 3A, the diagnostic matrix 550 may indicate, represent and/or correlate, in this example, with a near certitude (i.e., ˜100% chance) for a particular positive diagnostic result.

FIGS. 3B to 3G show the various ranges of accuracy—540a, 546a, 548a and 540b, 546b—broken out into separate diagnostic matrices 550. In this example, when the first and second points 440a, 440b fall within the boundaries of: the regions of accuracy 540a, 540b shown in the FIG. 3B, there may be a chance of at least ˜25% (˜50%×˜50%) of the diagnostic result; the regions of accuracy 546a, 540b shown in the FIG. 3C, there may be a chance of at least ˜37.5% (˜75%×˜50%); the regions of accuracy 548a, 540b shown in the FIG. 3D, there may be a chance of at least ˜50% (˜100%×˜50%); the regions of accuracy 540a, 546b shown in the FIG. 3E, there may be a chance of at least ˜50% (˜50%×—100%); and the regions of accuracy 546a, 546b shown in the FIG. 3F, there may be a chance of at least ˜75% (˜75%×˜100%) of the diagnostic result. These various permutations might be tabulated as follows:

| | Probability for | |
|---|---|---|
| | Particular Positive | Basis for |
| FIG. | Diagnostic Result | Calculation |
| 3B | ~25% | ~50% × ~50% |
| 3C | ~37.5% | ~75% × ~50% |
| 3D | ~50% | ~100% × ~50% |
| 3E | ~50% | ~50% × ~100% |
| 3F | ~75% | ~75% × ~100% |
| 3G | ~100% | ~100% × ~100% |

Each range of accuracy 540 (and as best seen in FIG. 3B) has minimum and maximum result values 542a, 542b and QC values 544a, 544b which may preferably together define the boundaries of the range 540.

Skilled persons may appreciate, in view of FIG. 4, that the regions of accuracy 540 may not be rectangular, but may in fact be any shape which is appropriate in the circumstances. FIG. 4 depicts a diagnostic matrix 550 having regions of accuracy 540 defined as ellipses, but they might also be irregularly shaped (not shown). Similar to FIG. 3A, FIG. 4 shows three ranges of accuracy 540a, 546a, 548a associated with the first point 440a (and with the first diagnostic test 210a); and two ranges of accuracy 540b, 546b associated with the second point 440b (and with the second diagnostic test 210b). It is contemplated that in some diagnostic matrices 550 it may be appropriate, depending on the circumstances including aggregated clinical data, for there to be regions and/or sub-regions of accuracy which are discrete/remote from one another (not shown) and yet all associated with a single point 440 and diagnostic test 210.

In an alternate embodiment, the result and QC coordinates 420, 430 associated with each of the various diagnostic tests 210 in the virtual test panel matrix 450 need not be plotted against one another to determine whether the resultant points 440 fall within corresponding ranges of accuracy 540. Instead, the processors 116, 125 may determine whether each of the result and QC coordinates 420, 430 falls between the corresponding minimum and maximum result values 542a, 542b and QC values 544a, 544b.

Any particular point 440 will fall within a corresponding range of accuracy 540 if the result and QC coordinates 420, 430 fall between the corresponding minimum and maximum result values 542a, 542b and QC values 544a, 544b.

FIG. 5 shows different auto-capture 110a, 110b (alternately, referenced herein by numerals “110a-b” or simply “110”) and other diagnostic devices 120 that might be used with local/remote software applications 112, 122 to capture or collect results 220 and clinical data or symptoms 20 according to the present invention.

An auto-capture device 110a may be provided with onboard/integral/local memory 118a and processors 116. The memory 118a may ephemerally, temporarily, semi-permanently or permanently encode a software application 112a (including a QC data module 113 and an auto-update module 114) which may be used to operatively encode the processors 116.

An alternate auto-capture device 110b may interface with a non-integral local/remote software application 112b (likewise including the QC data module 113 and auto-update module 114) which may be stored in a non-integral local/remote memory 118b and which may be used to operatively encode processors 116. In this alternate embodiment, the processors 116 may be integral/non-integral and local to/remote from the auto-capture device 110b. If locally provided, the memory 118b and processors 116 may be retrofitted such that the stored software application 112b is capable of near-integral use in association with the alternate auto-capture device 110b.

Test results 220 from other diagnostic devices 120 and/or based on observed clinical data or symptoms 20 may be collected using discrete processors 126 and another local/remote software application 122 which is preferably stored in a local/remote memory 118b. In this case, the software application 122 is additionally provided with a smart capture/collection module 125 and a QC data module 123. In this last respect, functions involving the QC data module 123 may involve and/or require answers to a number of QC questions/interrogatories in order to properly resolve the QC data 230.

The smart capture/collection module 125 associated with such devices 120 (e.g., smartphone) and/or symptoms 20 may be used, for example, to capture with a smartphone (e.g., by manual capture) various physiological data and/or biological parameters associated with the subjects—such as, for example, heart rate, color of the subject's face, and overall subject attitude. Such captured physiological data and/or biological parameters may be stored in the databases 200 or memory 118b as the test results 220.

One or more processors 116, 126 preferably apply the interpretation algorithms 320 and the QC protocols 330. The test results 220, QC data 230, result coordinates 420, and QC coordinates 430 may be stored in one or more databases 200 (as shown in FIG. 2) and/or further processed at a remote backend which is accessible via a portal 130 (as shown in FIG. 5). In view of the disclosures herein, skilled persons should appreciate that, when the software applications 112b, 122 are provided remotely of the auto-capture device 110b, the diagnostic device 120 and/or the symptoms 20 may be accessed via the portal 130 to the remote backend.

Thus, according to the invention, there is preferably provided a virtual diagnostic test panel device 110a, system 100, method and computer readable medium which are specifically adapted to automatically combine the results 220 from various devices 110a, 110b, 120 and symptoms 20 to test for diagnostic results in a biological or environmental subject other than those otherwise enabled. The virtual diagnostic test panel device 110a, system 100, method and computer readable medium preferably enables the use of results 220 from various devices 110a, 110b, 120 and symptoms 20 with one another. The virtual diagnostic test panel device 110a, system 100, method and computer readable medium preferably accounts for differing QC data 230 and QC protocols 330 on combining the various test results 220.

From the foregoing, persons having ordinary skill in the art may appreciate that the invention overcomes problems, avoids disadvantages associated with the prior art, and/or affords improved performance.

Two determinations are preferably processed by the device 110a, system 100, method and/or computer readable medium according to the invention, as follow:
I) The determination of the result coordinate 420 may preferably, but need not necessarily, be dependent upon and/or be a function of the test result 220 and/or interpretation algorithm 230 which may include various subject data (not shown), including age, gender, location, and/or temperature. For example,

Result Coordinate(RA)=Test Result(R)×Interpretation Algorithm(A)
II) The determination of the QC coordinate 430 may preferably, but need not necessarily, be dependent upon and/or be a function of the QC data 230 and/or the QC protocol 330 associated with the device, user, assay and/or test. For example,

QC Coordinate(QP)=QC Data(Q)×QC Protocol(P)

Preferably, for example, result coordinates 420 are associated as a first one of an X or a Y value on a (X/Y) coordinates system, and QC coordinates 430 are associated as an other one of the X or the Y value on the (X/Y) coordinates system, of the virtual test patent matrix 450.

In some embodiments of the present invention, one or more analyses of the virtual test panel matrix 450 and/or one or more of the factors comprising the test panel matrix 450 (such as test results 220, interpretation algorithms 320, QC data 230 and/or QC protocols 330) are preferably performed and/or associated with one or more of the following:
A) A test result 220 ranking algorithm may be applied in situations, for example, where greater emphasis should be placed on a specific diagnostic test 210 based, in whole or in part, on the clinical data;
B) A test panel matrix 450 ranking algorithm may be applied in situations, for example, where there are two or more test panel matrices 450 for a given subject and greater emphasis should be placed on a particular test panel matrix 450 based, in whole or in part, on the clinical data;
C) A test panel matrix 450 algorithm may be applied in situations, for example, (i) where it may be appropriate to vary the size and/or position of a given range of accuracy 540 based, in whole or in part, on the clinical data, and/or (ii) simply to compare the test panel matrix 450 against one or more of the diagnostic matrices 550.

In some embodiments of the present invention, one or more interpretations of the virtual test panel matrix 450 and/or one or more of the factors comprising the test patent matrix 450 (such as test results 220, interpretation algorithms 320, QC data 230 and/or QC protocols 330) are preferably performed and/or associated with one or more of the following:
i) A virtual test panel matrix 450 knowledge database may be applied in situations, for example, where it is appropriate to archive the test panel matrices 450 (e.g., accumulating clinical data to better define ranges of accuracy 540);
ii) A virtual test panel matrix 450 monitoring database may be used in situations, for example, where it may be desirable to monitor test panel matrices 450 (e.g., to determine the start, or conclusion, of a virulent outbreak in a community);
iii) A diagnostic result interpretation database may be applied in situations, for example, where it may be appropriate to provide at least some interpretation of a diagnostic result matching a given test panel matrix 450—with reference to the above example, if Cancer Z₀ is the diagnostic result, the interpretation database may also indicate a likelihood of metastases.

It should be appreciated that, although some of the components, relations, configurations and/or steps of the devices, systems, methods and computer readable media according to the invention are not specifically referenced in association with one another, they may be used, and/or adapted for use, in association therewith.

All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of any regular patent applications claiming priority herefrom.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

1. A system to virtually test for one or more diagnostic results in a biological or environmental subject, with the system comprising:
(a) one or more databases comprising:
(i) a first test result collected from a first diagnostic test; and first quality control (QC) data associated with the first test result;
(ii) a second test result collected from a second diagnostic test different than the first diagnostic test; and second QC data associated with the second test result;
(iii) one or more diagnostic matrices associated with the first diagnostic test, with the second diagnostic test, and with the biological or environmental subject; wherein each of the diagnostic matrices indicates at least a corresponding one of the diagnostic results;
(b) one or more processors operatively encoded to automatically:
(i) apply a first interpretation algorithm to generate a first result coordinate based on the first test result; and apply a first QC protocol to generate a first QC coordinate based on the first QC data;
(ii) apply a second interpretation algorithm to generate, based on the second test result, a second result coordinate on the same scale as the first result coordinate; and apply a second QC protocol to generate, based on the second QC data, a second QC coordinate on the same scale as the first QC coordinate; and
(iii) combine the first result coordinate, the first QC coordinate, the second result coordinate, and the second QC coordinate into a virtual test panel matrix; and when the virtual test panel matrix matches one or more of the diagnostic matrices, determine each said corresponding one of the diagnostic results which matches the virtual test panel matrix.

2. The system according to claim 1, wherein the first interpretation algorithm, the first QC protocol, the second interpretation algorithm, and the second QC protocol are stored in the databases; and wherein: (a) before the first interpretation algorithm is applied as aforesaid, the first interpretation algorithm is automatically retrieved from the databases; (b) after the first QC data is associated with the first test result, the first QC protocol is automatically retrieved from the databases and applied by the processors as aforesaid; (c) before the second interpretation algorithm is applied as aforesaid, the second interpretation algorithm is automatically retrieved from the databases; and (d) after the second QC data is associated with the second test result, the second QC protocol is automatically retrieved from the databases and applied by the processors as aforesaid.

3. The system according claim 1, wherein an update for at least one of the following is delivered to and stored in the databases: the first interpretation algorithm; the first QC protocol; the second interpretation algorithm; and the second QC protocol.

4. The system according to claim 1, wherein the first interpretation algorithm and the first QC protocol are adapted to generate the first result coordinate and the first QC coordinate as quantitative values or semi-quantitative values.

5. The system according to claim 1, wherein said one or more of the diagnostic matrices comprise at least a first range of accuracy for the first diagnostic test and a second range of accuracy for the second diagnostic test; and wherein the processors automatically match the virtual test panel matrix with said one or more of the diagnostic matrices, as aforesaid, when: (a) a first point, defined by the first result coordinate and the first QC coordinate, lies within the first range of accuracy; and (b) a second point, defined by the second result coordinate and the second QC coordinate, lies within the second range of accuracy.

6. The system according to claim 5, wherein the first range of accuracy and the second range of accuracy are dependent on aggregated clinical data concerning the first point, the second point, and the corresponding one of the diagnostic results.

7. The system according to claim 5, wherein the first range of accuracy is defined by minimum and maximum first result values matching the first result coordinate and by minimum and maximum first QC values matching the first QC coordinate; and wherein the second range of accuracy is defined by minimum and maximum second result values matching the second result coordinate and by minimum and maximum second QC values matching the second QC coordinate.

8. The system according to claim 1, wherein the first test result is clinical data stemming from a clinical examination.

9. The system according to claim 1, wherein the first test result and the first QC data are collected using a diagnostic device.

10. The system according to claim 9, wherein the diagnostic device is an auto-capture device which performs the first diagnostic test and automatically captures the first test result and the first QC data.

11. The system according to claim 9, wherein at least one of the databases is remote from the diagnostic device, and at least one of the processors is local to the diagnostic device.

12. The system according to claim 9, wherein at least one of the databases is local to the diagnostic device; and at least one of the processors is local to the diagnostic device.

13. The system according to claim 9, wherein the first QC data comprises at least one of the following: one or more QC results for an assay associated with the first test result; one or more calibration results for the diagnostic device; one or more functional check results for the diagnostic device; and one or more QC results for a user associated with the first test result.

14. The system according claim 9, wherein the first QC protocol is dependent on at least one of the following: an assay associated with the first test result; the diagnostic device; and a user associated with the first test result.

15. The system according to claim 1, wherein said one or more databases comprise a database distributed over a network.

16. The system according to claim 1, wherein said one or more databases comprise at least two congruent databases.

17. The system according to claim 1, wherein the first interpretation algorithm is dependent on at least one of the following: an age associated with the biological or environmental subject; a gender associated with the biological or environmental subject; a location associated with the biological or environmental subject; and a temperature associated with the biological or environmental subject.

18. A method to virtually test for one or more diagnostic results in a biological or environmental subject, with the method comprising:
(a) a database storage step of storing in one or more databases:
(i) a first test result collected from a first diagnostic test; and first quality control (QC) data associated with the first test result;
(ii) a second test result collected from a second diagnostic test different than the first diagnostic test; and second QC data associated with the second test result;
(iii) one or more diagnostic matrices associated with the first diagnostic test, with the second diagnostic test, and with the biological or environmental subject; wherein each of the diagnostic matrices indicates at least a corresponding one of the diagnostic results;
(b) a processing step of using one or more processors to automatically:
(i) apply a first interpretation algorithm to generate a first result coordinate based on the first test result; and apply a first QC protocol to generate a first QC coordinate based on the first QC data;
(ii) apply a second interpretation algorithm to generate, based on the second test result, a second result coordinate on the same scale as the first result coordinate; and apply a second QC protocol to generate, based on the second QC data, a second QC coordinate on the same scale as the first QC coordinate; and
(iii) combine the first result coordinate, the first QC coordinate, the second result coordinate, and the second QC coordinate into a virtual test panel matrix; and when the virtual test panel matrix matches one or more of the diagnostic matrices, determine each said corresponding one of the diagnostic results which matches the virtual test panel matrix.

19. The method according to claim 18, wherein in the database storage step, the first interpretation algorithm, the first QC protocol, the second interpretation algorithm, and the second QC protocol are stored in the databases; and wherein: (a) before the processing step, the first interpretation algorithm is automatically retrieved from the databases; (b) after the database storage step, the first QC protocol is automatically retrieved from the databases and applied by the processors as aforesaid; (c) before the processing step, the second interpretation algorithm is automatically retrieved from the databases; and (d) after the database storage step, the second QC protocol is automatically retrieved from the databases and applied by the processors as aforesaid.

20. The method according to claim 18, wherein in the database storage step, an update for at least one of the following is delivered to and stored in the databases: the first interpretation algorithm; the first QC protocol; the second interpretation algorithm; and the second QC protocol.

21. The method according to claim 18, wherein the first interpretation algorithm and the first QC protocol are adapted to generate, in the processing step, the first result coordinate and the first QC coordinate as quantitative values or semi-quantitative values.

22. The method according to claim 18, wherein in the database storage step, said one or more of the diagnostic matrices comprise at least a first range of accuracy for the first diagnostic test and a second range of accuracy for the second diagnostic test; and wherein in the processing step, the processors automatically match the virtual test panel matrix with said one or more of the diagnostic matrices, as aforesaid, when: (a) a first point, defined by the first result coordinate and the first QC coordinate, lies within the first range of accuracy; and (b) a second point, defined by the second result coordinate and the second QC coordinate, lies within the second range of accuracy.

23. The method according to claim 22, wherein before the processing step, the first range of accuracy and the second range of accuracy are determined in dependent relation on aggregated clinical data concerning the first point, the second point, and the corresponding one of the diagnostic results.

24. The method according to claim 22, wherein before the processing step: the first range of accuracy is defined by minimum and maximum first result values matching the first result coordinate and by minimum and maximum first QC values matching the first QC coordinate; and the second range of accuracy is defined by minimum and maximum second result values matching the second result coordinate and by minimum and maximum second QC values matching the second QC coordinate.

25. The method according to claim 18, wherein in the database storage step, the first test result is clinical data stemming from a clinical examination before the database storage step.

26. The method according to claim 18, further comprising a result collection step, before the database storage step, wherein the first test result and the first QC data are collected using a diagnostic device.

27. The method according to claim 26, wherein the diagnostic device is an auto-capture device which performs the first diagnostic test and, in the result collection step, automatically captures the first test result and the first QC data.

28. The method according to claim 26, wherein in the database storage step, at least one of the databases is remote from the diagnostic device; and in the processing step, at least one of the processors is local to the diagnostic device.

29. The method according to claim 26, wherein in the database storage step, at least one of the databases is local to the diagnostic device; and in the processing step, at least one of the processors is local to the diagnostic device.

30. The method according to claim 26 wherein in the database storage step, the first QC data comprises at least one of the following: one or more QC results for an assay associated with the first test result; one or more calibration results for the diagnostic device; one or more functional check results for the diagnostic device; and one or more QC results for a user associated with the first test result.

31. The method according to claim 26, wherein in the processing step, the first QC protocol is dependent on at least one of the following: an assay associated with the first test result; the diagnostic device; and a user associated with the first test result.

32. The method according to claim 18, wherein in the database storage step, said one or more databases comprise a database distributed over a network.

33. The method according to claim 18, wherein in the database storage step, said one or more databases comprise at least two congruent databases.

34. The method according to claim 18, wherein in the processing step, the first interpretation algorithm is dependent on at least one of the following: an age associated with the biological or environmental subject; a gender associated with the biological or environmental subject; a location associated with the biological or environmental subject; and a temperature associated with the biological or environmental subject.

35. A computer readable medium on which is stored instructions which upon execution will operate a system to virtually test for one or more diagnostic results in a biological or environmental subject, with the instructions comprising:
(a) instructions for storing in one or more databases:
(i) a first test result collected from a first diagnostic test; and first quality control (QC) data associated with the first test result;
(ii) a second test result collected from a second diagnostic test different than the first diagnostic test; and second QC data associated with the second test result;
(iii) one or more diagnostic matrices associated with the first diagnostic test, with the second diagnostic test, and with the biological or environmental subject; wherein each of the diagnostic matrices indicates at least a corresponding one of the diagnostic results;
(b) instructions for using one or more processors to automatically:
(i) apply a first interpretation algorithm to generate a first result coordinate based on the first test result; and apply a first QC protocol to generate a first QC coordinate based on the first QC data;
(ii) apply a second interpretation algorithm to generate, based on the second test result, a second result coordinate on the same scale as the first result coordinate; and apply a second QC protocol to generate, based on the second QC data, a second QC coordinate on the same scale as the first QC coordinate; and
(iii) combine the first result coordinate, the first QC coordinate, the second result coordinate, and the second QC coordinate into a virtual test panel matrix; and when the virtual test panel matrix matches one or more of the diagnostic matrices, determine each said corresponding one of the diagnostic results which matches the virtual test panel matrix.

36. A device to virtually test for one or more diagnostic results in a biological or environmental subject, with the device comprising:
(a) an auto-capture module which automatically captures: a first test result from a first diagnostic test; and first quality control (QC) data associated with the first test result;
(b) at least one memory locally storing:
(i) the first test result and the first QC data;
(ii) a virtual test panel matrix comprising: a second result coordinate based on a second test result collected from a second diagnostic test different than the first diagnostic test; and a second QC coordinate based on second QC data associated with the second test result; and
(iii) one or more diagnostic matrices associated with the first diagnostic test, with the second diagnostic test, and with the biological or environmental subject; wherein each of the diagnostic matrices indicates at least a corresponding one of the diagnostic results;
(c) one or more processors operatively encoded to automatically:
(i) apply a first interpretation algorithm to generate, based on the first test result, a first result coordinate on the same scale as the second result coordinate; and apply a first QC protocol to generate, based on the first QC data, a first QC coordinate on the same scale as the second QC coordinate;
(ii) integrate the first result coordinate and the first QC coordinate into the virtual test panel matrix; and
(iii) when the virtual test panel matrix matches one or more of the diagnostic matrices, determine each said corresponding one of the diagnostic results which matches the virtual test panel matrix.

37. The device according to claim 36, adapted for use with one or more databases; wherein the first interpretation algorithm and the first QC protocol are stored in the databases; and wherein: (a) before the first interpretation algorithm is applied as aforesaid, the first interpretation algorithm is automatically retrieved from the databases; and (b) after the first QC data is associated with the first test result, the first QC protocol is automatically retrieved from the databases.

38. The device according to claim 37, wherein at least one of the databases is remote from the device.

39. The device according to claim 37, further comprising a communication element which delivers an update for the first interpretation algorithm and/or the first QC protocol for storage in the databases.

40. The device according to claim 37, wherein the memory stores at least one of the databases.

41. The device according to claim 36, wherein the first interpretation algorithm and the first QC protocol are adapted so the processors generate the first result coordinate and the first QC coordinate as quantitative values or semi-quantitative values.

42. The device according to claim 36, wherein said one or more of the diagnostic matrices comprise at least a first range of accuracy for the first diagnostic test and a second range of accuracy for the second diagnostic test; and wherein the processors automatically match the virtual test panel matrix with said one or more of the diagnostic matrices, as aforesaid, when: (a) a first point, defined by the first result coordinate and the first QC coordinate, lies within the first range of accuracy; and (b) a second point, defined by the second result coordinate and the second QC coordinate, lies within the second range of accuracy.

43. The device according to claim 42, wherein the first range of accuracy and the second range of accuracy are dependent on aggregated clinical data concerning the first point, the second point, and the corresponding one of the diagnostic results.

44. The device according to claim 42, wherein the first range of accuracy is defined by minimum and maximum first result values matching the first result coordinate and by minimum and maximum first QC values matching the first QC coordinate; and wherein the second range of accuracy is defined by minimum and maximum second result values matching the second result coordinate and by minimum and maximum second QC values matching the second QC coordinate.

45. The device according to claim 36, wherein the first QC data comprises at least one of the following: one or more QC results for an assay associated with the first test result; one or more calibration results for the device; one or more functional check results for the device; and one or more QC results for a user associated with the first test result.

46. The device according to claim 36, wherein the first QC protocol is dependent on at least one of the following: an assay associated with the first test result; the device; and a user associated with the first test result.

47. The device according to claim 36, wherein the first interpretation algorithm is dependent on at least one of the following: an age associated with the biological or environmental subject; a gender associated with the biological or environmental subject; a location associated with the biological or environmental subject; and a temperature associated with the biological or environmental subject.
